(19) United States
(12) Patent Application Publication
(10) Pub. No.: US 2016/0030840 A1
(43) Pub. Date: Feb. 4, 2016

(54) STACK ROSTER FANTASY SPORTS GAME AND PLATFORM

(71) Applicant: Sport Gamet International LLC, Wilmington, DE (US)

(72) Inventor: Thomas Dermonte Stephenson, JR., Lake Stevens, WA (US)

(21) Appl. No.: 14/857,008

(22) Filed: Sep. 17, 2015

Related U.S. Application Data
(63) Continuation-in-part of application No. 14/074,376, filed on Nov. 7, 2013.
(60) Provisional application No. 61/840,303, filed on Jun. 27, 2013.

(51) Int. Cl. A63F 13/35; A63F 13/795; A63F 13/46; A63F 13/828

(52) U.S. Cl. CPC A63F 13/35; A63F 13/828; A63F 13/795; A63F 13/46

(57) ABSTRACT

A method and system for playing a fantasy sport competition among a plurality of Users, includes instructions stored on a non-transitory computer readable medium for transmitting User selections to suitably order Players in the User roster. Any User requests to commence a draft. An order of the draft selection is generated. A user is granted an opportunity to request an assertion of an Enhancement. Enhancements are selected from a list comprising a blocking enhancement to move a User-selected User to the end of the generated order of selection and an immunity enhancement to move a User to the beginning of the generated order of selection. If a User generates such a request for assertion of an Enhancement, the order of selection of Players is changed to add, in turn, to each User's roster of Players.

### PRIORITY CLAIM

This application is a Continuation-In-Part of U.S. application Ser. No. 14/074,376, filed on Nov. 7, 2013; which claims the benefit of U.S. Provisional Application No. 61/840,303 filed on Jun. 27, 2013, the contents of which are incorporated herein by reference.

### FIELD OF THE INVENTION

The present invention is a game played by several players on a network and more specifically a fantasy sports game.

### BACKGROUND OF THE INVENTION

Fantasy sports have enjoyed a longer and more consistent growth over the three decades since they were introduced largely due to their inherent virality. Virality is a metric that has been borrowed from the field of epidemiology. It pertains to how quickly an element or content spreads through the population. The virality can be attributed to Fantasy Sports fulfilling a need in the spectator's enjoyment of the sport. Normally, sports are enjoyed as a purely passive activity. Fantasy Sports, however, add an active component by allowing the grouping of Players into teams and scoring those teams in accord with each Player's performance over a set interval. Selection of those teams gives an active element to watching sports.

Determining standings in a season generally occurs at fixed intervals because standings rely upon statistics derived from diverse events. For example, baseball games may occur three times a week for one team and as many as five times a week for another team and the schedule will vary from week to week. A User may have team members drawn from each of several teams with distinct schedules and match ups. Thus, algorithms used for generating standings may be updated, for example, either daily or weekly.

Because scores rely upon diverse games to make up any one User's standing, the play of fantasy sports is inherently asynchronous, which is to say that two Users will not necessarily know at the same time what scores they have derived from a week of play. Unlike watching an event such as the Super Bowl, two fantasy sports Users will not generally come together to watch a single event as their individual standings may not rely upon that event. Standings do not require any two persons competing thereby to be communicatively connected to each other to play, once each User has drafted his or her team. The draft is the one occasion for gathering the Users in a league, into each other's presence or at least in communication over a computer network.

For purposes of clarity within this discussion, the two terms “User” and “Player” will be defined in a fashion that may or may not have their normal meaning to the reader. There is an inherent confusion in the use of the word “Player” in fantasy sports. Some use Player to describe a contestant in the Fantasy league and that use confuses the athletes with the contestants in the fantasy sports leagues. Uniformly in this application, “Players” will refer to the athletes competing in their respective sports and generating statistics that are used to derive standings. A “User”, on the other hand, will refer to an individual or contestant who engages in fantasy game play as a manager, deriving standings based upon the performance of selected Players competing in a sport. “Players” would include baseball players, basketball players, soccer players, football players, race car drivers/race cars, mixed martial artists, etc. Users will only compete by comparison of standings. Further, an “Instigating User” is one of the Users who designates at least one other User (herein “Invited User”) to compete with, thereby to initiate a fantasy sports competition.

In a similar manner, some other sports terms are defined from a User's eye view, throughout. The term “Season” is any defined interval of competition between Users; as used herein, the season may coincide with a season as recognized by the governing authorities of the various sports or it may be one defined by the Users, such as a single day of competition. Seasons can even span multiple years, if the Users so define the Season. Any interval of play for which statistics can be reliably garnered the Users can define as a Season.

Fantasy sport involves team sports and the Drafting of a team requires various Player positions to be filled in order to initiate a Season. The number of Players a User claims is dependent upon the rules of the sport the Player is playing and/or the manner in which each individual fantasy sports game is devised, and would therefore the number of Players varies from sport to sport and even further from league to league.

Any team sport can be used as a principal component is selecting Players to make up a team. Users manage a roster of Players drawn from any group for whom statistics are compiled. In each of the possible sports ranging from NFL football to MLS soccer to NASCAR racing and those many other sports for which news sources publish statistics, a fantasy sport game exploiting those statistics can be devised.

Users rely upon their ability to acquire and field a team of Players pursuant to such rules as the group of Users define or adopt. Users compete against one another receiving points for their acquired Players' real life statistics as the Players compete in their real life sports. Any injury or other impediment a Player suffers in the season is reflected in the resulting statistics a Player garners for the season in question. Similarly, any particularly good performance will shift a Player's statistics upward. In short, just as a real-life general manager in a sport must contend with the vagaries of the performance of human athletes that make up his team, so, too, does the fantasy sports User. As such, the fantasy player User gets to sample, vicariously, the sensations ABC™ Sports touts as the “thrill of victory and the agony of defeat” by imparting a personal stake in each Player's performance.

The advent of powerful computers and the Internet revolutionized fantasy sports, allowing scoring and deriving standings to be done entirely by computer, and, thereby, allowing leagues to develop their own scoring systems, often based on less popular statistics. In this way, for example, fantasy baseball has become a sort of real-time simulation of baseball, and allowed many fans to develop a more sophisticated understanding of how the real-world game works. According to statistics from a 2009 article in Forbes, nearly 11 million people play fantasy baseball today, in all fantasy sports, Ad Week estimates nearly 32 million people.

Generally, as the play in all fantasy sports centers on the manager's staffing decisions, the teams are rated on the performance of each of a roster of athletes and the associated statistics they accumulate as the season progresses. Users, as managers, often draft teams before the season begins (or very shortly thereafter). Because the draft decisions are the principal determinant of success or failure relative to other players in a given league, the draft suggests itself as a principal vehicle for introducing game play factors to change the character of the standard fantasy league play.

Conventionally, fantasy league drafts are straightforward and engineered to assure that there is equal risk across the User group. In conventional sequential selection, a User who gets the first selection opportunity would, then, always lead in selection in subsequent rounds, therefore would always have the strongest team. In a league with eight Users, for each round of eight Players selected, assuming well-informed Users, if the selection order does not vary, the first User will always get the best of the eight players chosen in that round. In each subsequent round the same User would get the best Player of each subsequent group of eight. In the end, more of the talent would be unfairly concentrated in this first User's team. Because of the effects of selection multiply, should one Player have an amazingly good season, that one Player's results, when included in those of the team is unlikely to have a significant effect upon the standings in spite of the brilliance of play. Because the outcome is a foregone conclusion among well-informed Users, conventional play with a sequential draft is not very interesting.

One approach used in conventional play to spread out the talent in the course of a draft, is to convert the draft into an auction. In such an auction, each User has a fixed amount of money with which to bid for athletes and each User must fill his or her team's roster without exceeding the budget. By limiting the resources available for purchase of Player's contracts, the league enforces a more uniform distribution of talent and rewards the prudent User. Who spends a great deal in early rounds has little left for final rounds, thereby leveling the opportunity available to each User.

Still another conventional approach to avoid the effects that would occur in a sequential draft is to conduct Player selection by employing a serpentine draft. In a serpentine draft the order by which the Users select Players is inverted in each round from that of the preceding round. Adhering to this serpentine order, the User that had been first and had the opportunity to select the best of the eight Players selected is now the last and will take the least of those eight. Over the course of the draft, the opportunity is spread across the Users to effect rough equality in selection. While fairer, the serpentine system is still too predictable for engaging play.

Because selecting Players is the key issue that defines the play of any fantasy sports game relative to mark performance as against other Users, the selection process can uniquely define the outcomes of each Season played. Deviations from conventional play are needed to introduce a quality of unpredictability in the course of the draft. What is needed in the art is a structure of variants, each additional variant of the selection process creating a distinct order and, thereby, a distinct game.

### SUMMARY OF THE INVENTION

A method and system for playing a fantasy sport competition among a plurality of Users, includes instructions stored on a non-transitory computer readable medium for transmitting User selections to suitably order Players in the User roster comprising a User prioritized list of Players according to positions, such that for each position the User has reflected a plurality of choices in order of User preferences.

### BRIEF DESCRIPTION OF THE DRAWINGS

Preferred and alternative examples of the present invention are described in detail below with reference to the following drawings:

FIG. 1A is a graphical representation of first step in an exemplary interface for enabling a “draft” for a fantasy sports game;

FIG. 1B is a graphical representation of second step in an exemplary interface for enabling a “draft” for a fantasy sports game;

FIG. 1C is a graphical representation of third step in an exemplary interface for enabling a “draft” for a fantasy sports game;

FIG. 2A is a graphical representation of the resulting roster in an exemplary interface for enabling an Immunity Enhancement for a fantasy sports game;

FIG. 2B is a graphical representation of the resulting roster in an exemplary interface for enabling a Blocking Enhancement for a fantasy sports game;

FIG. 3A is a block diagram of a networked system for implementing a “thin client” embodiment of an enhancement-capable draft;

FIG. 3B is a block diagram of the networked system for implementing the “thin client” embodiment of the enhancement-capable draft demonstrating a reporting interface;

FIG. 3C is a block diagram of the networked system for implementing the “thin client” embodiment of the enhancement-capable draft demonstrating the reporting interface at a point of game completion; and,

FIG. 3D is a block diagram of a server for the networked system, implementing the “thin client” embodiment of the enhancement-capable draft.

### DETAILED DESCRIPTION OF THE PREFERRED EMBODIMENT

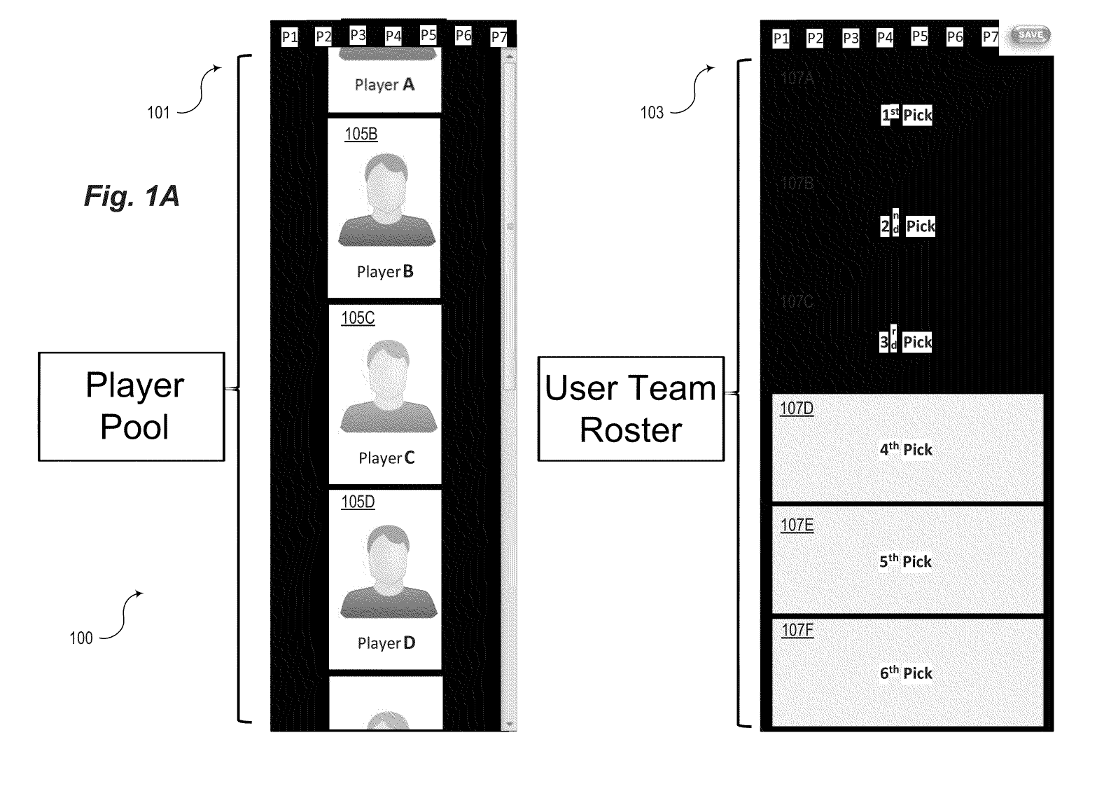

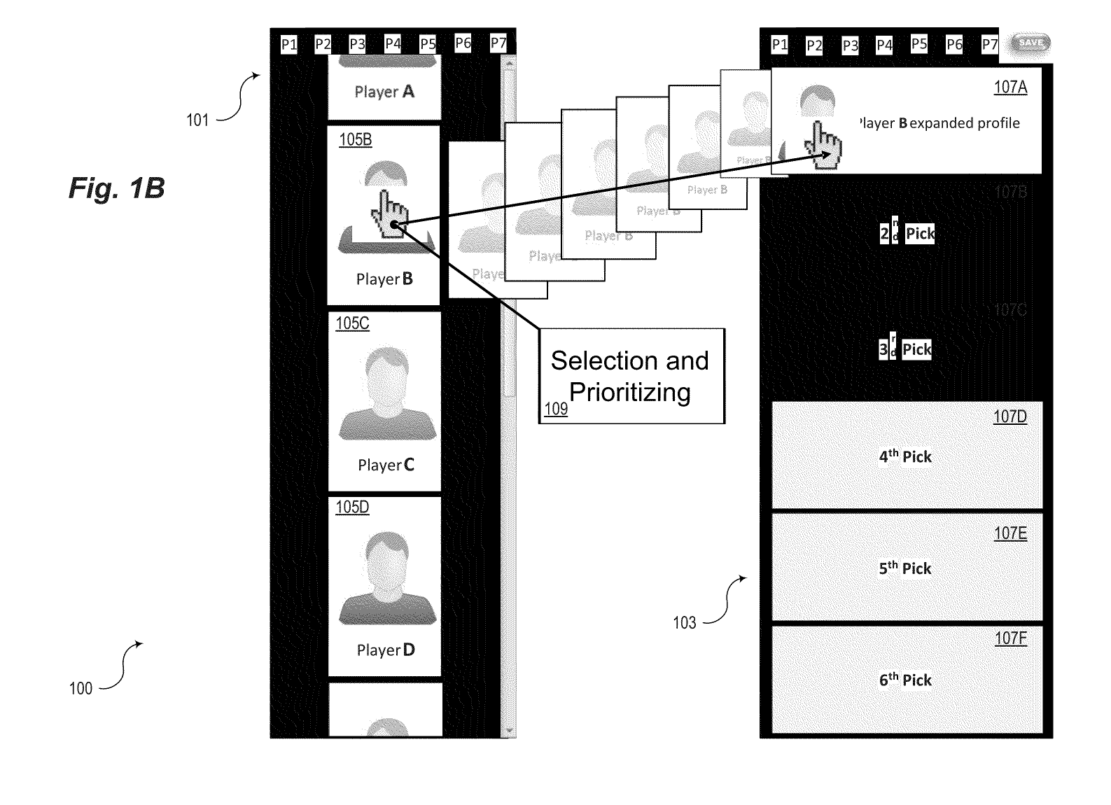

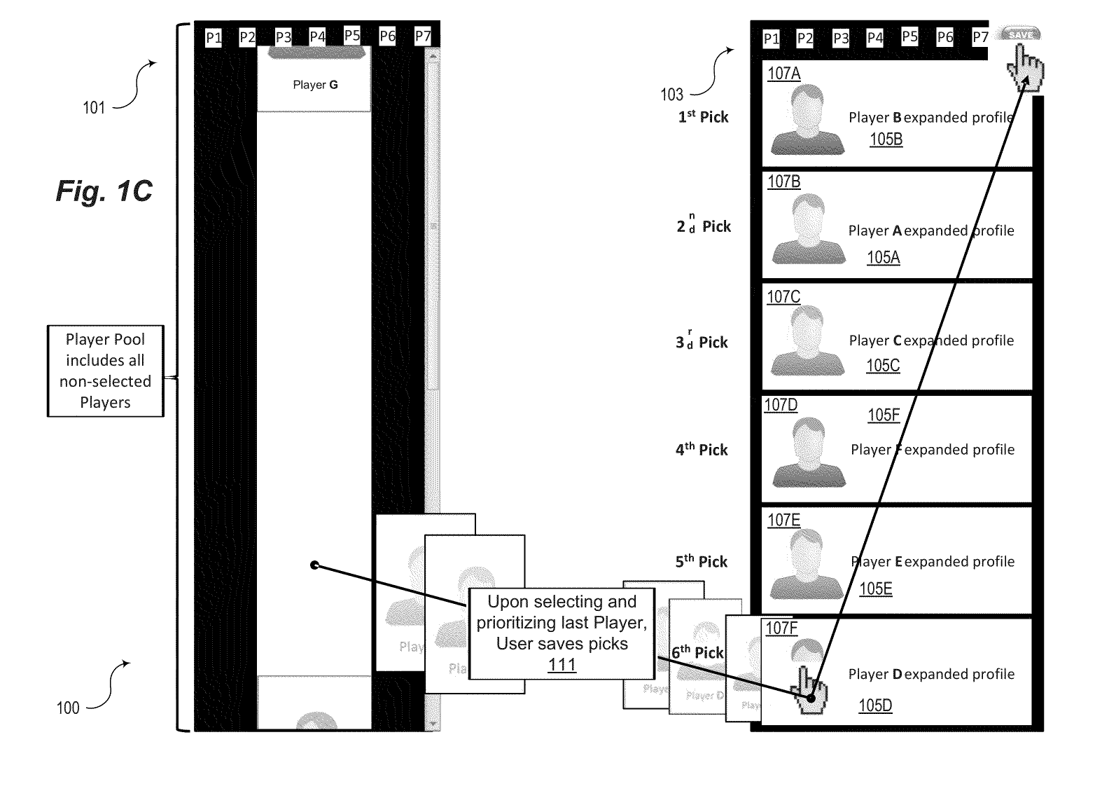

By way of overview, the draft defines fantasy sports play and orders the User's selection of Players. The mechanics of a draft that enables a User's selection of Players for play through a Season among a group of Users (“League”) is described herein. Understanding that the invention is practiced on a network and an inventive interface facilitates communication between and among the Users, the interface removes the conventional requirement that the Users be in the physical presence one of another. The interface illustrated herein that clearly reports to all Users the immediate status of the draft and is generally represented in interaction with the User in FIGS. 1 through 3D.

In describing this invention, Users, to qualify, register on a game server (described below) creating a profile and account in order to participate. Thus, in one presently preferred embodiment of the invention, a user must first create a User profile in order to login to the system (in most cases according to conventional methods, for example, using the Username and corresponding Password for that User's previously established account).

Once the User has the ability to log into their account on the game server, the User would, in one exemplary embodiment, elect to navigate into the “Game Store” and select “Acquire Enhancement.” Upon selection, the User would move to an “Enhancement Options” screen specific to the particular sport for which they have established a profile.

Acquisition of the Enhancement may be through a purchase, for example in exchange for a cost (for purposes of the nonlimiting example, expressed in US dollars) for each particular Enhancement. The user would then make their selection(s) and the Enhancements would be placed into a shopping cart. Alternatively, the acquisition may be through an exchange of some token or “virtual currency” earned or purchased through prior play on the server. In one embodiment, virtual currency would also be expressed in terms of buying power, i.e. US dollars in this example. Once the User has elected by which terms the acquisition would take place, the User would be “taken” to the “check out” page where the Enhancement(s) previously selected would be listed. After the User approves of the terms of exchange and affirms the conditions of the acquisition, the User's profile is credited with ownership of the Enhancement(s). Upon completing the transaction, the User is free to utilize said Enhancement(s) in game play.

Embodiments of the inventive game include two Enhancements. These two will be used to explain the concepts attendant to “Enhancement” even as further specific enhancements are explained below. The first exemplary Enhancement is based upon User selection of a particular player. The second Enhancement is based upon actions in a particular round of the draft. The first Enhancement is used offensively as it assures the User of a specific Player selection; the second Enhancement is used defensively as it prevents another Player from making a selection. Respectively, they are called, herein, the Immunity Enhancement and the Blocking Enhancement—and they are the sword and the shield in practicing the inventive draft.

Importantly, the interface described herein has, as its principal purpose facilitating a Process as that term is understood in 35 U.S.C. §101. Processes have always been patentable and at its core the interface facilitates the Process, i.e. the draft by a predetermined set of rules. The goal is to allow Users to select Players in sequential and repeatable steps. The Enhancements, themselves are each processes performed in sequential and repeatable steps implicated by a User's acquisition and execution of one of the two Enhancements.

Beginning with a User's eye view of the Process as exemplified by the interface, at FIG. 1, an Instigating User, after appropriately logging into the system, providing such information and funds as are necessary to qualify for participation, is presented with an interface screen 100 having two principal features, generally similarly configured roster elements: 1) a Player pool 101; and 2) a User Team Roster. In the presently preferred embodiment, these roster elements are as shown, but the invention could be practiced with graphic elements that display players identities such as tile-like icons shown in FIG. 1A and referred to as “tiles” 105B, 105C, and 105D and graphically represented receptacles to receive those tiles referred to as “slots” (The non-limiting examples set forth here shows a fantasy sports draft for an National Football League (American rules professional football), though nothing inherently limits the application to any particular sport as is explained below). While these same functions could as easily be represented in a range of graphic representations, even in a simplest form in textual lists representing each of the Player pool 101 and the User team roster 103, the graphic representations shown in FIG. 1A is most readily adapted to this explanation of game play.

The Player pool in this embodiment is further divided by positions as the particular User league may define a standard roster. For example, such positions might include a quarterback, a running back, a wide-receiver and a tight end in NFL™ football and, by contrast, a pitcher, a catcher, and a first baseman, etc. in MLB™ baseball. Similarly each other sport would have its own designation for such positions. In order to facilitate display identities of the numerous players that would make up a roster, the configuration of the presently preferred embodiment may optionally be divided into pages, each page representing a position as the sport defines it. Thus the pool 101 is divided into pages such as 101P1, 101P2 etc. while the User team roster is similarly divided into pages such as 103P1, 103P2, etc. Advantageously, in the presently preferred embodiment, selecting a page on one of the pool 101 or the roster 103 will result in both the pool 101 and the roster 103 displaying the corresponding pages, e.g. selecting page 2 in the roster will cause page 2 to display in each of the roster and the pool.

In some sports, such as NASCAR™ auto racing, generally only drivers receive recognition with published statistics and so there are no distinct positions but rather a team comprising several drivers. For such sports, the pool 101 and the roster 103 may not be divided into individual positions as there is no useful distinction that would make such a division useful. In such a case, the position would not be necessary or included to selectively display distinct portions of the roster 103 and the pool 101.

For the purposes of the Draft, each User is given the opportunity to select a Player for the User's team. There are three variant embodiments, each defining an order for each User to make their selections. With the exception of the order of selection, each embodiment is otherwise identical in its effect and method of execution. In the first embodiment, Users select their Players in serial order just as is described in the Background section above, relying upon the inventive enhancements to break up the advantage yielded to the first User in order. In a second embodiment, the draft proceeds in the serpentine method also described in the background section above. The third generates an order randomly for each distinct round of the draft thereby ameliorating the effects of order of selection as a determinate of Player rosters.

Finally, there exists an embodiment not reliant upon order at all. Rather than exploiting an order of selection, Users select players in accord with the method as laid out in one of the Inventor's other inventions, the “Stack Roster Fantasy Sports Game and Platform”, as that game is described in U.S. patent application Ser. No. 14/074,376 filed on Nov. 7, 2013 and fully incorporated herein by this reference.

In any of the foregoing embodiments, each User must now populate that User's team roster 103 from the Player candidates listed in the pool 101. The inventive interface 100 communicates those selections to all Users alike as that interface 100 is shown in FIGS. 1A-1C. Once again, as earlier stated, the presently preferred embodiment involves moving tiles 105B, 105C, and 105D from the pool 101 to the Users individual team roster 103 to occupy one of the slots 107A, 107B, 107C, 107D, 107E, and 107F. (In the envisioned interface 100, any User can view all of the individual Users' individual team rosters 103 as well as the pool 101 at any time. For the sake of the explanation of this interface, the view has been limited to that of the pool 101 and one User's roster 101 to simplify the explanation of the mechanics of selection and communication the interface 100 facilitates. The invention is not intended to be limited to this one interface 100, as the invention may be practiced in several alternate embodiments, including, as discussed above, the simple use of textual lists.) Each choice, when the exemplary interface 100 is used, includes the graphic representation of tiles moving from the pool 101 to the User's roster 103.

FIG. 1B illustrates the presently preferred embodiment of the interface 101 effecting movement of Players from the pool 101 to the User's team roster 103 and further to illustrate prioritization of the User's team roster 103, through the use of tiles 105B, 105C, and 105D and slots 107A, 107B, 107C, 107D, 107E, and 107F. As stated above, a User populates the team roster 103, as shown in FIG. 1B by dragging a tile in a selecting move 109, in this case tile 103B to one of the vacant slots, in this case 107A, on the User team roster 103 and as a result achieves at least two of the instant invention's constituent steps, one of selecting a Player and one of placing a priority on the Player.

The graphic interface 100 inherently presents certain advantages in that the movement of tiles such as tile 103B inherently removes the player from the pool 101 to the roster 103 preventing duplicate designations of Players as being on the User's team roster 103. Further, in one nonlimiting embodiment of the interface, once a User defines for which position the User is searching, i.e. by selecting, in this example, one of P1, P2, P3, P4, P5, P6, or P7, the displayed portion of the pool 101 is limited, then to only those Players eligible to play in the selected position.

For clarity, references to FIGS. 1B and 1C describe the progress of the draft with any User taking advantage of the inventive Enhancements. Such is not to say they could not be used in regular play but rather, to give an example as a baseline for explanation. In such play, each User continues selecting Players in the manner described above until all of the slots 107A, 107B, 107C, 107D, 107E, and 107F. (Six slots being shown only as a non-limiting example; the invention can be practiced with more or fewer slots as selected rules may dictate). The User may also move a Player tile 105B from one slot 107A to another slot 107C to adjust priority among the several choices until all six of the slots 107A, 107B, 107C, 107D, 107E, and 107F are filled and ordered according to the priority the User places on each Player. Likewise, the User progresses through each of the positions, moving from page 101P1 through 101P7 of the pool and similarly through pages 103P1 through 103P7. The interface works to afford the User suitable opportunity to make selections and set priorities throughout the User team roster.

Referring to FIG. 1C, at some point, the User has completely populated, reviewed and prioritized the User's team roster 103 by filing, in this non-limiting case slot 107A with Player B's tile 105B, slot 107B with Player A's tile 105A, slot 107C with Player C's tile 105C, slot 107D with Player F's tile, slot 107E with Player E's tile 105E, slot 107F with Player D's tile 105D and has similarly filed each of the other player positions 103P2, 103P3, 103P4, 103P5, 103P6 and 103P7 to populate each to reflect selections and organize the selections at each position according to the User's priorities. Having suitably filled the roster 103, the User executes a save by clicking 111 the “Save” button on the roster 103.

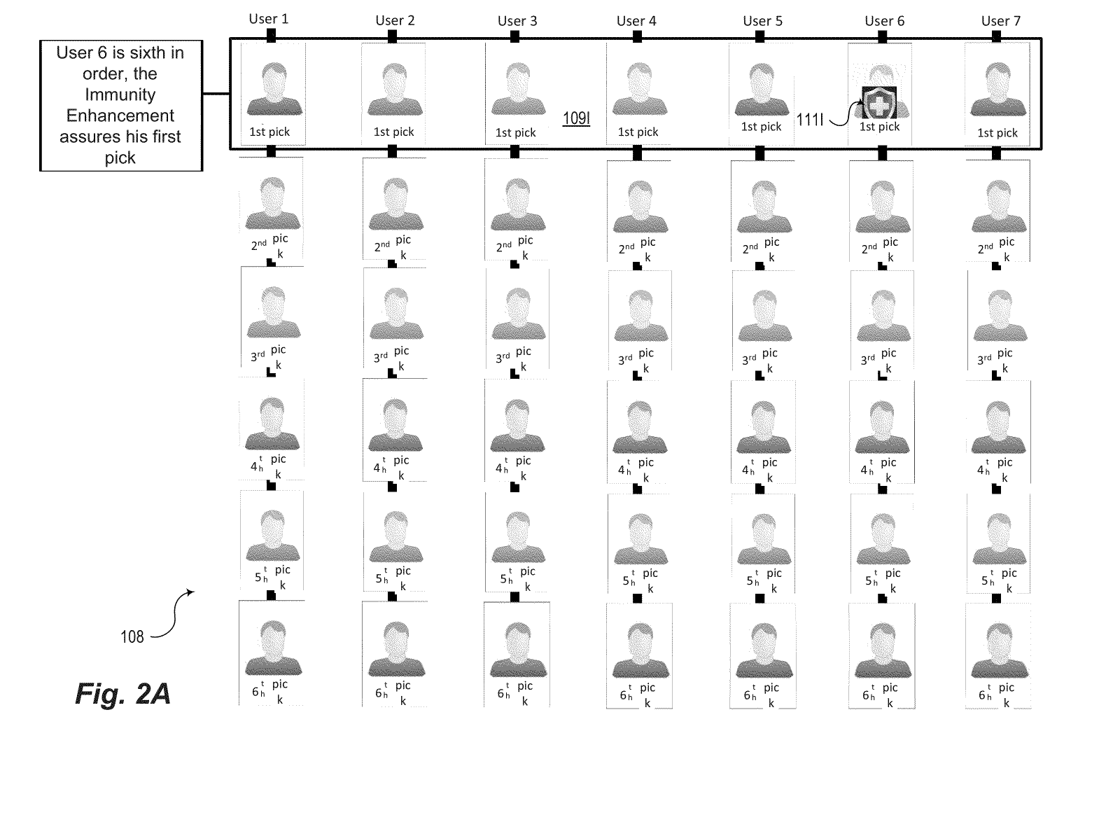

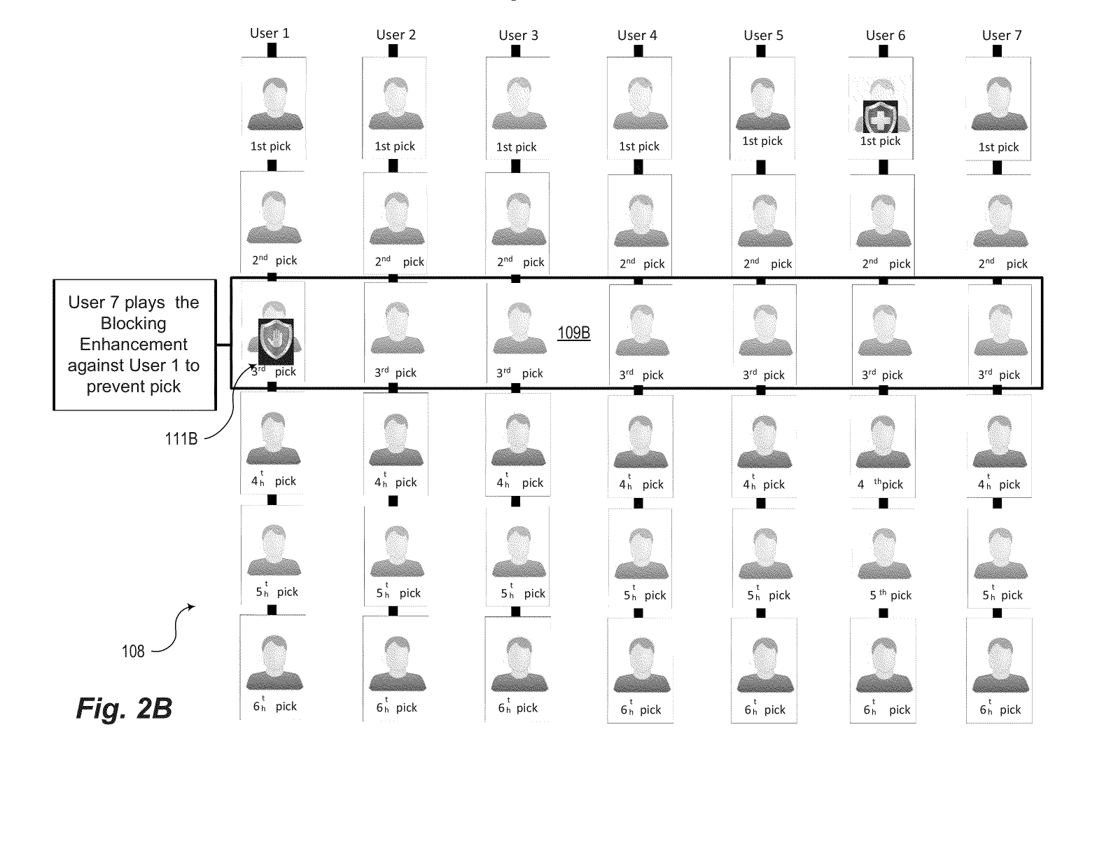

Having now described the workings of the interface, we move to the enhancements. The Immunity Enhancement is depicted in FIG. 2A, as that Enhance is briefly described above; a User might purchase the first exemplary Enhancement referred to herein as the “Immunity Enhancement”. In any round 109I of the Draft 108 (shown in this FIG. 2A as the first round 109I, but only as a nonlimiting example), a User wishing to do so may assert an Immunity Enhancement 111I if that User has purchased such an Enhancement 111I causing it to be associated with his or her account. Enhancements are asserted and, thus, consumed at the beginning of any relevant round of the draft.

When asserted, the Immunity Enhancement 111I allows a User to select, out of order, any Player remaining in the Pool 103. Enhancements are used before the first User in each round makes their picks of Players. In the embodiment where the order of the Users in any given round is selected by random chance, the Enhancements have to be asserted before the order of the round is selected so that if that same User is then selected as first in order, that User has consumed the Immunity Enhancement in vain. That vanity of such an assertion injects some risk with each contemplated assertion and makes the draft more interesting. As a result, User 6 will automatically select first in that round.

Likewise, the use of the Immunity Enhancement 111I in the Stack Roster embodiment assures the User of receiving their choice in that round. Unlike the other variants of the Immunity Enhancement 111I, within the context of the Stack Roster, the Immunity Enhancement is used against a specific User. The Stack Roster allows play among several Users by creating simultaneous games wherein pairs of Users submit their Stack Rosters as denoting all of their draft picks of Players in their order of their preference at each position within the team roster. As between each possible pair of players within the league, the Stack Rosters are then reconciled by the Stack Roster Engine to create rosters relative to each of the games played by the pairs. One User's roster relative to a second User is distinct from what it is relative to a third User. Thus, when a User seeks to exercise the Immunity Enhancement 111I in the context of Stack Roster Play, it only grants that User the first pick relative to the other User the first User designates.

In the context of explaining play of the Enhancement relative to the interface, the User seeking to exercise the Immunity Enhancement 111I does so by placing it over the Player selection in the User's Stack Roster to indicate the Player for which it is intended so that when the stack rosters are reconciled, that Player will belong to the User asserting the Immunity Enhancement even if the other User in the pair has selected the Player as an earlier pick in their own Stack Roster. Just as in the non-Stack Roster embodiments of the invention, if, by chance, the Player would have gone to that asserting User even without the benefit of asserting the Immunity Enhancement 111I, the User has consumed the Immunity Enhancement 111I without receiving a distinct benefit for having done so.

Moving now to the Blocking Enhancement 111B, FIG. 2B, depicts its use in a later round of the draft (signified as later by the presence of the earlier use of the Immunity Enhancement). In the exemplary use of the Blocking Enhancement 111B, User 7 may realize that User 1 is building a team around a passing game. As the draft develops, User 7 perceives that User 1 will likely pick a wide receiver in the next round and also perceives that a particularly good wide receiver is available. To assure that the User 1 will not be able to complete the team, User 7 asserts the Blocking Enhancement 111B in this the third round of the draft. As such, User 1 is moved to the last position in that round of the draft and is unable to select as the wide receiver Player User 1 desires, as, for example, given the Blocking Enhancement 111B, User 2 decides to pick that Player taking him out of the pool 103. Use of the Blocking Enhancement 111B does not, necessarily improve selection for User 7, the User asserting the Blocking Enhancement 111B but does directly affect the User asserted against, in this case, User 1, by blocking the ability to obtain that desired Player. As described above, one can readily see the offensive and defensive nature of these two Enhancements.

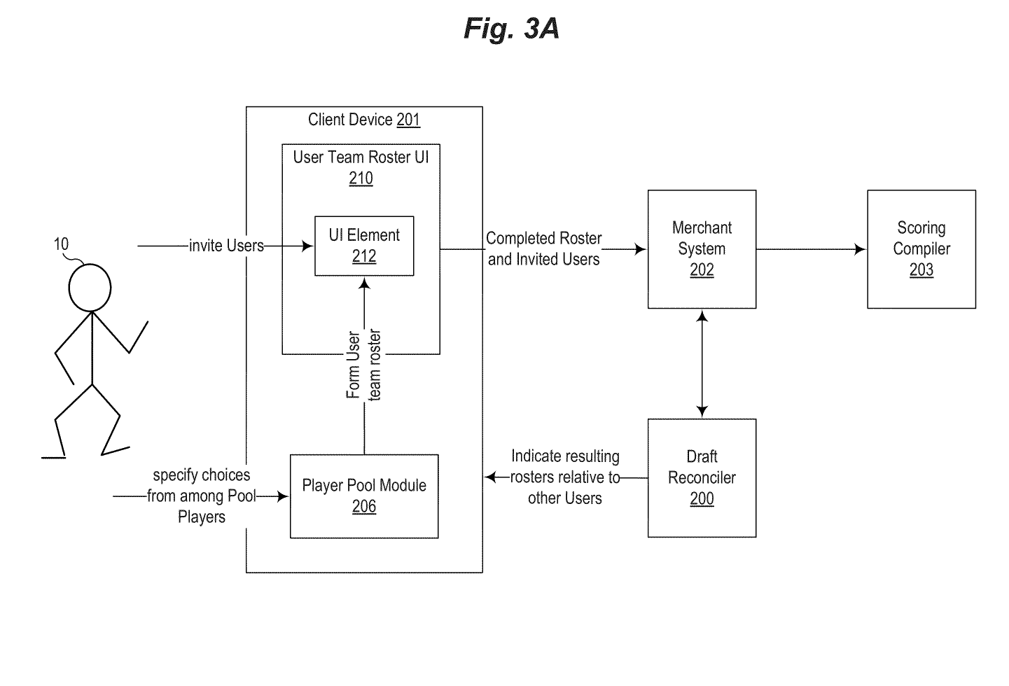

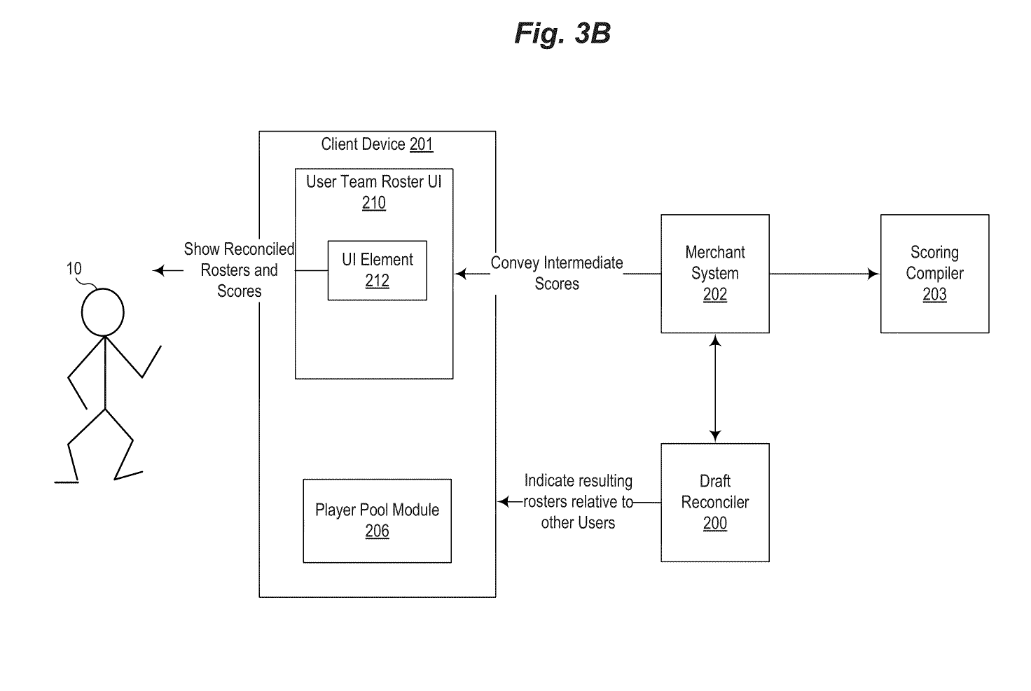

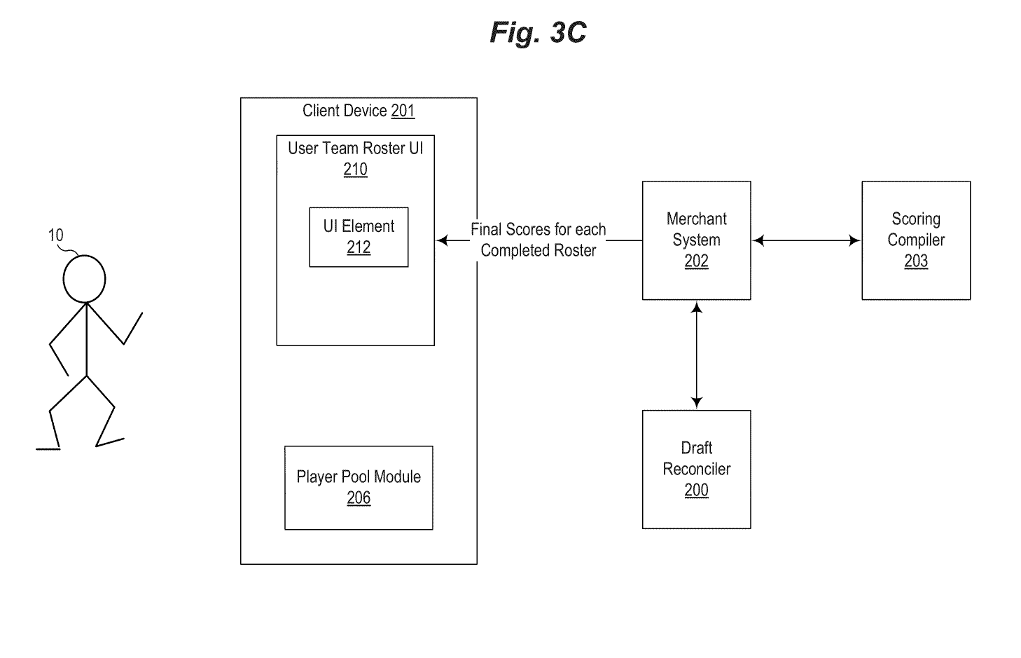

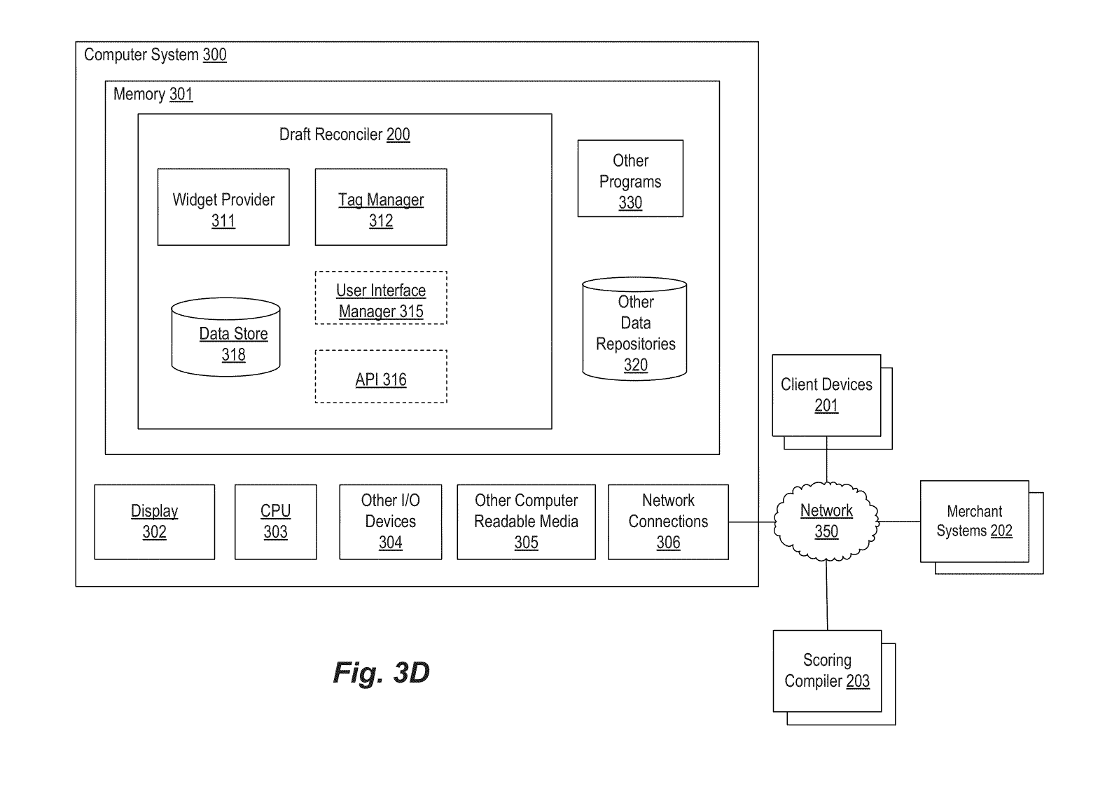

FIGS. 3A-3C are example block diagrams illustrating data flows within the game play platform according to example embodiments. FIG. 3A illustrates an arrangement of systems, modules, and devices according to one embodiment. The illustrated arrangement includes a draft reconciler 200 (used to track movements of Players onto User's individual rosters), a client device 201, a merchant system 202, and a scoring compiler system 203. The client device 201 is operated by a User 10 who employs the client device in order the process of entering Player selection information for the purposes of effectuating formation of a User team roster 103 (prior Figures) by or authentication of eligibility via a merchant system 202. The modules, systems, and devices illustrated with respect to FIGS. 3A-3C may be differently arranged, operated, or constituted in other embodiments. For example, the merchant system 202 and the scoring compiler 203 may be merged as a single system and operated by a single entity. In other embodiments, a third party provider may be present to either authenticate a User or to replace one or more functions of the merchant system 202 or to provide the functions of the scoring compiler system 203.

The client device 201 includes a User Team Roster interface (“UI”) 210 and a Player Pool module 206. Examples of the UI 210 are described with respect to FIGS. 1A-1C, above. The UI 210 is typically provided by the merchant system 202, such as when the UI 210 is implemented as part of a Web page received from a Web-based e-commerce system hosted or provided by the merchant system 202. In other embodiments, the UI 210 may be part of a standalone client application, such as a draft desktop or mobile application.

The UI 210 includes a user interface element 212. The UI element 212 may be any control, field, aspect, or other portion of the UI 210. For example, the UI element 212 may be a text field, a drop down menu, a selection group, a chooser, a button, a hidden field, or the like. In some embodiments, the user 10 may interact with the UI element 212, such as by clicking and dragging a movable control, editing a text field or pressing a button. In other embodiments, UI element 212 is inactive with respect to direct user interaction. For example, the UI element 212 may be a draggable element within a list control and/or a text element in a document tree that represents the UI 210.

In the illustrated example, the User 10 specifies a Player for a position via the UI element 212. Specifying other Users to interact with using the Draft platform may include entering (e.g., typing) a user's name, team name or other information into an editable text field. In other embodiments, User selection options may include interacting with a drop down or other selection control to set or store the User profile information item (e.g., an address, phone number) in the UI element 212.

Then, the User 10 specifies a particular fantasy sport in order to select a Player pool from which to construct a roster 206 and also to uniquely designate an identity for this User team roster to facilitate multiple rosters within a given sport for the User. In the illustrated example, the module 206 is received from the Draft reconciler 200. For example, the module 206 may be a Web page or popup (possibly including JavaScript or other code) displayed via a Web browser of the client device 201. The Web page may include a user interface as well as corresponding logic for facilitating the specification of extended Player options. Example user interfaces of example modules are discussed in more detail with respect to FIGS. 1A-1C, above.

Once the User 10 has specified the unique User team roster 103, the module 206 determines, generates, or prepares a series of slots ordered to various positions in accord with the User's 10 selection in a manner as described above. The indication may be a textual representation of identity of the User team roster, such as a fictitious name or code that includes an alphabetic string (e.g., “HAL”), a numeric string (e.g., “1001”), an alphanumeric string (e.g., “APPT7”), a symbolic string (e.g., “%**!”), or some combination of the preceding. The indication of the User team roster may also or instead be or include a binary (e.g., not human-readable) representation of the User team roster item. In some embodiments, the name or code may be generated by the UI based upon a name given by the User. In some instances, the selection of a particular sport may generate an indication specifically for that sport.

In another embodiment, the indication may be a network identifier that identifies (directly or indirectly) a network-accessible computing system or module that is configured to provide the Player Pool information for that selected sport upon request. For example, the indication may be a network address, a host name, a uniform resource identifier, or the like. The indication will typically further include an identifier, key, or other argument that can be used by the network-accessible computing system to look up or otherwise access the second Player information.

The draft commences as the Users invited to compete are verified as registered. The merchant system 202 confirms the readiness of the Users to begin the draft. In an exemplary embodiment, the merchant system 202 begins the draft by first inquiring if any of the Users have any Enhancement they wish to assert. Should any User assert an Enhancement, that User indicates to the merchant system 202 through the UI element 212 which Enhancement is to asserted and exhausted as set forth above and the merchant system 202 generates instructions of the draft reconciler. By way of nonlimiting example, in an embodiment where the order of Users to exercise their Player selections in each round is generated by random means, the merchant system 202 alerts the Users to the order generated for that round prior to the first selection. The UI element 212 then receives the first User's Player selection and, in accord with the illustrations set forth in FIGS. 1A through 1C conforms each of the User roster and the Player pool to the User's selection. Having completed that selection, the merchant system 202 moves to the next User in order. In turn, each User, using the UI element 212 generates a roster and asserts such Enhancements as are available to them. Through this process a team roster is generated.

The construction of the User team roster 103 is facilitated by the UI element 212. This may be a manual or automatic process. For example, the module 206 may instruct the user 10 to enter (e.g., type or copy-paste) the indication of the User team roster 103 into the UI element 212. In another approach, the module 206 may automatically modify the UI element 212 to include the indication of the User team roster as shown in FIGS. 1A-1C. For example, the module 206 may access the UI element 212 (e.g., by looking up its identifier in a DOM or other document data structure) and then modify the data stored in the element 212 (e.g., a slots 107 in the User team roster) to also include the indication of a Player selections by the User 10. Similarly, any purchases of Enhancements as describe above are facilitated by the merchant system 202 as are assertions of those Enhancements.

Next, the User team roster UI 210 transmits the User team roster and the indication of the Player selections and any assertions of Enhancements, along with attendant data as graphically represented in 103 (FIGS. 2A, 2B) to the merchant system 202. In some embodiments, the indication of the User team roster 103 will be transmitted along with some or all of the User profile. For example, if the indication of the User team roster includes a tag that has been inserted into data structure of the User team roster, such that when the User team roster (including the tag) will be transmitted to the merchant system 202, the merchant system can verify the User's entitlement to play and consequently transmitting the User's team roster to the draft reconciler 200. The User team roster, may, in a similar manner contain a tag indicating identities of other Users selected to play in a particular game using this User team roster 103. In other examples, the indication may be transmitted as a distinct element of a data structure allowing the indication to be stored distinctly from the indication.

The merchant system 202 may then process the received User team roster, the invitations, and the User 10 profile. For example, the merchant system 202 may User address verification, profile modifications, or similar operations based on its role in assure User payment to play. Doing so may include parsing out or extracting the indication of the User profile identification from User team roster so that the profile (or other information) stored therein can be isolated for purposes of payment verification or designating invited Users from a pool of such data stored in the User profile. In other embodiments, the merchant system 202 does not include any logic for processing (and does not otherwise interpret) one or more of the received User invitation information items. In such embodiments, the merchant system 202 may receive the invited User information with the User team roster that includes a tag as embedded within the invited and then forward or otherwise transmit the received items to some other system, such as the Scoring Compiler 203. In other embodiments, the invited User information is sent from the UI element 212 to the draft reconciler 200 through network means without the Merchant System altering the data structure.

After receiving and possibly processing the User team roster and included data items, the merchant system 202 may forward the items onwards to the draft reconciler 200 for each of the invited Users after each User has been verified in the Merchant System 202. The draft reconciler then conducts the draft using the interface described above and the User rosters 103 are compiled User choices and Enhancement Assertions in order to cause the Scoring Compiler to initiate a new competition as requested by the user 10. Once each User is verified, optionally to include the status of having paid, the reconciling of the rosters according to the outcome of the draft in light of the Enhancements occurs.

At a FIG. 3B, the intermediate play is shown. Once the draft has determined the rosters, the power of the computer is applied to generate standings. As a result of the actions of the draft reconciler 200, the fully reconciled rosters are either returned to the Merchant system, or, in a non-depicted embodiment, the draft reconciler 200 sends the reconciled rosters to the Scoring Compiler 203. One of the functions of the Scoring Compiler 203 is to garner all statistics for all players, and in a presently preferred embodiment, third party vendors send the information to the Scoring Compiler 203 using either of a “push” or a “pull” configuration to garner statistics on each of the Players represented by each of the tiles in the Player pool 101 as shown in FIG. 1A. In collecting all relevant statistics, the Scoring Compiler 203 serves as a data store of the latest and also historic statistics for each of the Players for perusal by the Users as well as for, ultimately, scoring the competition. In one embodiment, the tiles 105 A-E will include either the statistics themselves or a link directing the UI Element 212 to the statistics supplied by the Scoring Compiler 203 for display to inform the User in the Player selection process, as shown in FIGS. 1A through 1C.

The Scoring Compiler 203 (or, as described above, the Merchant System 202 in communication with the Scoring Compiler 203) then interprets the received statistics and performs the appropriate or necessary functions to score each of the reconciled rosters, such as delivering intermediate scores to the UI element 212 for display on the Client Device 201, displaying standings, creating and storing specific User statistics such as scoring for distinct positions in the roster 103. The Scoring Compiler 203 may also transmit to the Player Pool Module statistics to enable Users to compile unique and new User team rosters for play, for example in Major League Baseball™, a second season after the All-Star break.

FIG. 3C illustrates data flows in an embodiment to complete the season. The arrangement of components and systems shown in FIG. 3C is similar to that of FIGS. 3A and B. In FIG. 3C, the Merchant System uses a network identifier to facilitate transmission of and access to extended all User team rosters and the reconciled Rosters as between several Users. In the completion of the competition The Merchant System 202, in an embodiment, compiles the statistical data for the season drawing from the Scoring Compiler 203 to generate and provide standings posted at a uniform resource identifier (“URI”) that identifies a network-accessible system that is configured to provide the standings to each User in response to a request. In other embodiments, the URI may be directly parsed to determine an standings without interaction with a remote system. In some embodiments, a standings may be determined from the URI (e.g., as an embedded tag) and the UI element 212 directly, as standings may be determined by interacting based on the URI with a remote system.

Generating the URI by the Merchant System 202 may include interacting with the Draft reconciler 200. For example, the Merchant System may transmit specified game information including User profiles to the Draft reconciler 200, and after receiving the data, retrieves the appropriate statistics from the Scoring Compiler 203 to generate standings there for publication.

In an embodiment, the URI generated by the Merchant system 202 is then entered into the UI element 212 for display, as discussed above. In this example, the merchant system 202 forwards the reconciled rosters and the URI to the UI Element. The Scoring Compiler 203 then determines the specified those persons available for play based upon the setting of such an option within the User's profile, determining the appropriate URI, and then by communicating, based on the URI, with the Draft reconciler 200. More particularly, the Scoring Compiler 203 transmits to the facilitator 200 a request based on the URI. In an HTTP-based embodiment, the request may be an HTTP GET that includes URI parameters, including any key-value pairs or other arguments that were part of the URI (e.g., id=12345). The Reconciler 200 then determines the scoring based on the competition identifier, such as by looking up the particular reconciled rosters based on a received identifier. The Draft reconciler 200 then transmits the standings back to the UI element 212.

Note that the illustrated arrangement of modules may be differently constituted in some embodiments. For example, the Player Pool module 206 may be incorporated dynamically into the Scoring Compiler 203, as discussed with respect to FIG. 3B, above. As another example, the merchant system 202 and the Scoring Compiler 203 may be integrated as a single system, rather than as distinct systems as shown. Furthermore, the Draft reconciler 200 may be a component of one of the other modules, such as the Scoring Compiler 203 or the merchant system 202.

In other embodiments, additional modules or systems may also be present. For example, some embodiments may include a third-party statistics (“TPL”) provider that stores the statistics on the Scoring Compiler 203 to produce the resulting User scores.

Example embodiments described herein provide applications, tools, data structures and other support to implement a Draft reconciler to be used to provide a platform for gaming. Other embodiments of the described techniques may be used for other purposes, including for extending a user interface generally and/or using an existing communication protocol or data records to provide, carry, or transmit information beyond that which the protocol is designed to represent or transport. In the following description, numerous specific details are set forth, such as data formats and code sequences, and the like, in order to provide a thorough understanding of the described techniques. The embodiments described also can be practiced without some of the specific details described herein, or with other specific details, such as changes with respect to the ordering of the logic, different logic, or the like. Thus, the scope of the techniques and/or functions described are not limited by the particular order, selection, or decomposition of aspects described with reference to any particular routine, module, component, and the like.

FIG. 3D is an example block diagram of an example computing server system 300 for implementing a draft reconciler 200 in a networked environment according to an exemplary embodiment. In particular, FIGS. 3A, 3B, and 3C show a computing system 300 that may be utilized to implement a draft reconciler 200.

Note that one or more general purpose or special purpose computing systems/devices suitably instructed may be used to implement the draft reconciler 200. In addition, the computing system 300 may comprise one or more distinct computing systems/devices and may span distributed locations. Furthermore, each block shown may represent one or more such blocks as appropriate to a specific embodiment or may be combined with other blocks. Also, the draft reconciler 200 may be implemented in software, hardware, firmware, or in some combination to achieve the capabilities described herein.

In the embodiment shown, computing system 300 comprises a computer memory (“memory”) 301, a display 302, one or more Central Processing Units (“CPU”) 303, Input/Output devices 304 (e.g., keyboard, mouse, CRT or LCD display, and the like), other computer-readable media 405, and network connections 306 connected to a network 350. The Draft reconciler 200 is shown residing in memory 301. In other embodiments, some portion of the contents, some or all of the components of the Draft reconciler 200 may be stored on and/or transmitted over the other computer-readable media 305. The components of the Draft reconciler 200 preferably execute on one or more CPUs 303 and facilitate the reconciliation of rosters and ultimately the scoring options as described herein. Other code or programs 330 (e.g., an administrative interface, a Web server, and the like) and potentially other data repositories, such as data repository 320, also reside in the memory 301, and preferably execute on one or more CPUs 303. Of note, one or more of the components in FIG. 3D may not be present in any specific implementation. For example, some embodiments may not provide other computer-readable media 305 or a display 302.

The Draft reconciler 200, in one embodiment, includes a widget provider 311, a tag manager 312, a user interface manager 315, a application program interface (API) 316, and a data store 318. In other embodiments, functions performed by one or more of the illustrated components may be performed externally to the Draft reconciler 200.

The Draft reconciler 200 interacts via the network 350 with client devices 201, merchant systems 202, and Scoring Compiler 203. The network 350 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. In some embodiments, the network 350 may be or include multiple distinct communication channels or mechanisms. The client devices 201 include mobile phones, smart phones, personal digital assistants, laptop computers, tablet computers, desktop computers, and the like.

Users or others (e.g., customer service representatives) may use the client devices 201 to construct User team rosters 103 or other items via the merchant systems 202. The merchant systems 202 in turn prepare User profiles, invite Users to play, facilitate online chats and conveys statistics garnered from the Scoring Compiler 203. The Scoring Compilers 203 are used to, at least garner and store Player statistics from sources including from third party vendors.

The widget provider 311 manages the storage and distribution of various modules, blocks, widgets, or the like to enable enhance functionality and to increase the appeal of the game during play, such as an online chat between Users in a particular game to enable “smack talk” among the Users. Another such widget might distribute latest Player interview clips to Users having selected that Player on their User team roster. For example, a developer may create a new widget and provide the widget to the Draft reconciler 200 for storage and further distribution by the widget provider 311. The widget provider 311 may respond to requests received from client devices 201 or merchant systems 202 during the season. For example, a User may use one of the client devices 201 to interact with a Web page that includes a link to a Bank page that gives Users credits for later games based upon instantaneous standings, the link causing a widget to be retrieved by the client device 201 from the widget provider 311.

The tag manager 312 performs tag generation and translation services. For example, given a User and a User roster, the tag manager 312 may generate a tag that is configured to represent that information. The tag manager 312 may also, given a tag or other identifier, respond with the other User rosters specified by the identifier. In some embodiments, some or all of the logic of the tag manager may be incorporated into a widget or a Scoring Compiler 203.

The UI manager 315 provides a view and a controller that facilitate user interaction with the Draft reconciler 200 and its various components. For example, the UI manager 315 may provide interactive access to the Draft reconciler 200, such that users or systems can obtain or configure widgets, generate tags, translate tags, and the like. In some embodiments, access to the functionality of the UI manager 315 may be provided via a Web server, possibly executing as one of the other programs 330. In such embodiments, a user operating a Web browser (or other client) executing on one of the devices/systems 201, 202, and/or 203 can interact with the Draft reconciler 200 via the UI manager 315.

The API 316 provides programmatic access to one or more functions of the draft reconciler 200. For example, the API 316 may provide a programmatic interface to one or more functions of the Draft reconciler 200 that may be invoked by one of the other programs 330 or some other module. In this manner, the API 316 facilitates the development of third-party software, such as user interfaces, widgets, tag translation services (e.g., for integrating functions of the Draft reconciler 200 into Web applications), and the like. In addition, the API 316 may be in at least some embodiments invoked or otherwise accessed via remote entities, such as one of the Scoring Compilers 203, to access various functions of the Draft reconciler 200.

The data store 318 is used by the other modules of the draft reconciler 200 to store and/or communicate information. The components of the system 200 use the data store 318 to record various types of information, including widgets and other controls, information about scoring and statistics provided by third-party vendors. Although the components of the system 300 are described as communicating primarily through the data store 318, other communication mechanisms are contemplated, including message passing, function calls, pipes, sockets, shared memory, and the like.

In an example embodiment, components/modules of the draft reconciler 200 are implemented using standard programming techniques. For example, the Draft reconciler 200 may be implemented as a “native” executable running on the CPU 303, along with one or more static or dynamic libraries. In other embodiments, the Draft reconciler 200 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the Draft reconciler 200, such as in the data store 318, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 318 may be implemented as one or more database systems, file systems, or any other technique for storing such information, or any combination of the above, including implementations using distributed computing techniques.

Different configurations and locations of programs and data are contemplated for use with techniques of described herein. In addition, the modules may reside on client or server systems that are physical or virtual computing. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the Draft reconciler 200 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored as non-transitory contents on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for playing a fantasy sport competition among a plurality of Users, the method comprising:
by a client device having instructions stored on a non-transitory computer readable medium, the device being communicatively connected to a network:
transmitting User selections to suitably order Players in the User roster comprising a User prioritized list of Players according to positions, such that for each position the User has reflected a plurality of choices in order of User preference;
by the server having instructions stored on a non-transitory computer readable medium, the server being communicatively connected to the network:
receiving from any User a request, if a User generates such a request, for assertion of an Enhancement for varying an order of selection of Players to add to each User's roster of Players;
generating an order of selection in a round of a fantasy sport draft, the order of selection determining an order by which Users may enter selections;
modifying the generated order of selection to reflect requested assertions of Enhancements, the Enhancements selected from a list comprising a blocking enhancement to move a User-selected User to the end of the generated order of selection and an immunity enhancement to move a User to the beginning of the generated order of selection;
receiving each User's selection of a Player in accord with the modified generated order of selection, amending each User's roster to reflect the selection; and,
upon completing the modified generated order of selection, commencing a next round of the draft until all Users have filled appropriately their respective User's roster.

2. The method of claim 1, further comprising;
by the server:
receiving Player statistics reflecting actual play during a relevant period; and
generating scores for each of the User according to the received Player statistics for each Player in each User roster of Players.

3. The method of claim 2, further comprising:
By the server:
compiling the scores for the User and the Invited User for each Stack Roster pair, and
generating standings based upon comparing compiled scores for each of the User and the Invited Users.

4. The method of claim 1, wherein transmitting User selections to suitably order Players in the User roster further comprises:
by the client device:
transmitting information identifying the User; and
receiving a list of Players available for User selection ordered according to Player positions; and
by the server:
generating the list of Players; and
transmitting the list of Players available for selection.

5. The method of claim 1 wherein receiving from any User a request, if a User generates such a request further comprises:
by the client device:
transmitting User information to a merchant services component; and,
transmitting information identifying User requested assertion of Enhancement to server;
by the server:
receiving User information;
receiving information identifying User-requested assertion of Enhancement to server, and modifying the generated order of selection to reflect User-requested assertion.

6. The method of claim 1 wherein the commencing a next round of the draft comprises:
verifying each User's selections by position to assure User's selections appropriately fill each of the available positions;
when each User has suitably filled each of the available positions, generating User rosters for each User in accord with the selections and
associating the User roster with the User for use in the fantasy sports game.

7. A system for facilitating Users in the play of a fantasy sport game, the system comprising:
a Merchant System residing upon a server having instructions stored on a non-transitory computer readable medium, the server being communicatively connected to the network, the Merchant System being configured to:
generate from the plurality of registered Users a league of Users to compete in the fantasy sports game;
generate, for each User in the league, an empty User roster to store Player selections;
receive from any one of the Users in the league of Users, a request to commence a draft of Players; and
a draft reconciler, communicatively connected to the merchant system, comprises:
a data store containing each of the User Player rosters received from the merchant system;
a memory having instructions stored on a non-transitory computer readable medium; and
a central processing unit which, in response to the instructions performs a method including:
receiving from any User a request, if a User generates such a request, for assertion of an Enhancement for varying an order of selection of Players to add to each User's roster of Players;
generating an order of selection in a round of a fantasy sport draft, the order of selection determining an order by which Users may enter selections;
modifying the generated order of selection to reflect requested assertions of Enhancements, the Enhancements selected from a list comprising a blocking enhancement to move a User-selected User to the end of the generated order of selection and an immunity enhancement to move a User to the beginning of the generated order of selection;
receiving each User's selection of a Player in accord with the modified generated order of selection, amending each User's roster to reflect the selection; and
storing each User's selection of the Player in that User's roster of Players;
the Scoring Compiler, communicative coupled to the draft reconciler and the merchant system and comprising:
a data store for receiving statistics for each Player in each User Player roster; and
calculating scores for the league, based upon Player statistics relevant to a defined period.

8. The system of claim 7, wherein the instruction causing the center processing unit to, according to User rosters, comprise instructions to perform the method including:
for each User in each Stack Roster pairing, retrieving each Users' roster of Players for each position; and
comparing the each User's roster of Players to the positions to determine if the draft is complete;
storing each User's roster in association with the User and the league of Users.

9. The system of claim 7 wherein, the merchant system receives calculated scores for each User from the Stack Roster and transmits the scores to each User at designated intervals.

10. A computer having instructions stored on a non-transitory computer readable medium, the device being communicatively connected to a network to facilitate playing a fantasy sport competition among a plurality of Users, the computer comprising:
instructions stored on the non-transitory computer readable medium causing the central processing unit to perform the following operations:
receiving from any User a request, if a User generates such a request, for assertion of an Enhancement for varying an order of selection of Players to add to each User's roster of Players;
generating an order of selection in a round of a fantasy sport draft, the order of selection determining an order by which Users may enter selections;
modifying the generated order of selection to reflect requested assertions of Enhancements, the Enhancements selected from a list comprising a blocking enhancement to move a User-selected User to the end of the generated order of selection and an immunity enhancement to move a User to the beginning of the generated order of selection;
receiving each User's selection of a Player in accord with the modified generated order of selection, amending each User's roster to reflect the selection; and,
upon completing the modified generated order of selection, commencing a next round of the draft until all Users have filled appropriately their respective User's roster.

11. The computer of claim 10, further comprising;
receiving Player statistics reflecting actual play during a relevant period; and
generating scores for each of the User according to the received Player statistics for each Player in each User roster of Players.

12. The computer of claim 11, further comprising:
By the server:
By the server:
compiling the scores for the User and the Invited User for each Stack Roster pair, and
generating standings based upon comparing compiled scores for each of the User and the Invited Users.

13. The computer of claim 10, wherein transmitting User selections to suitably order Players in the User roster further comprises:
by the client device:
transmitting information identifying the User; and
receiving a list of Players available for User selection ordered according to Player positions; and
by the server:
generating the list of Players; and
transmitting the list of Players available for selection.

14. The computer of claim 10 wherein receiving additional User rosters from each additional User further comprises:
by the client device:
transmitting User information to a merchant services component; and,
transmitting information identifying User requested assertion of Enhancement to server;
by the server:
receiving User information;
receiving information identifying User-requested assertion of Enhancement to server, and
modifying the generated order of selection to reflect User-requested assertion.

15. The computer of claim 10 wherein the transmitting User selections designating additional Users further comprises:
verifying each User's selections by position to assure User's selections appropriately fill each of the available positions;
when each User has suitably filled each of the available positions, generating User rosters for each User in accord with the selections and
associating the User roster with the User for use in the fantasy sports game.
